(19) United States
(12) Patent Application Publication
(10) Pub. No.: US 2004/0206539 A1
(43) Pub. Date: Oct. 21, 2004

(54) Communication system, communication system management method, interconnecting device, interconnecting device controlling method, program and recording medium

(75) Inventor: Sohya Saito, Tokyo (JP)

Correspondence Address: RYUKA, 1-24-12 SHINJUKU, SIXTH FLOOR, TOSHIN BUILDING, SHINJUKU-KU, TOKYO, 160-0022, JP

(73) Assignee: ALLIED TELESIS K.K., Tokyo (JP)

(21) Appl. No.: 10/063,909

(22) Filed: May 23, 2002

Related U.S. Application Data
(63) Continuation of application No. PCT/JP01/11163, filed on Dec. 20, 2001.

(51) Int. Cl. H04B 10/08; H04B 10/00

(52) U.S. Cl. 174/68.1

(57) ABSTRACT

A communication system includes a first interconnecting apparatus connected to an external network; a second interconnecting apparatus connected to the first interconnecting apparatus; and a first management apparatus, connected to the first interconnecting apparatus and the second interconnecting apparatus, for managing the second interconnecting apparatus. The first interconnecting apparatus includes a first interconnecting unit for receiving a management command, which is an instruction for management of the second interconnecting apparatus from the external network, and for transmitting the management command to the first management apparatus. The first management apparatus includes a first management command receive unit for receiving the management command from the first interconnecting apparatus.

### CROSS REFERENCE TO RELATED APPLICATIONS

This patent application is a continuation application of PCT/JP01/11163 filed in Japan on Dec. 20, 2001 the contents of which are incorporated herein by reference.

### BACKGROUND OF INVENTION

1. Field of the Invention

The present invention relates to a communication system, a communication system management method, an interconnecting device, an interconnecting device controlling method, a program and a recording medium.

2. Description of the Related Art

With recent widespread home use of the Internet, it is expected that high-speed communication lines capable of delivering large amount of data, such as audio data, image data and movie data, via the Internet will be realized. In order to satisfy such demand, FTTH (Fiber To The Home), in which optical fibers are provided to the home, and the like, has been expanded.

At an office or the home, many media converters for performing media conversion between the optical fibers and a UTP (Unshielded Twisted Pair) cable are used in order to connect the optical fibers to interconnecting devices such as routers, terminals and the like. Especially, in a building having a plurality of offices and an apartment building, a network having a large number of interconnecting devices containing media converters is formed.

Since such a network is commonly used by many companies or homes, it is desirable that the network be managed with reduced management work and lower management cost.

### SUMMARY OF INVENTION

Therefore, it is an object of the present invention to provide a communication system, a communication system management method, an interconnecting device, an interconnecting device controlling method, a program and a recording medium, which are capable of overcoming the above drawbacks accompanying the conventional art. The above and other objects can be achieved by combinations described in the independent claims. The dependent claims define further advantageous and exemplary combinations of the present invention.

According to a first aspect of the present invention, a communication system includes a first interconnecting apparatus connected to an external network; a second interconnecting apparatus connected to the first interconnecting apparatus; and a first management apparatus, connected to the first interconnecting apparatus and the second interconnecting apparatus, and operable to manage the second interconnecting apparatus. The first interconnecting apparatus includes a first interconnecting unit operable to receive a management command from the external network, which is an instruction for management of the second interconnecting apparatus, and to transmit the management command to the first management apparatus. The first management apparatus includes a first management command receive unit operable to receive the management command from the first interconnecting apparatus.

The second interconnecting apparatus may include a second interconnecting unit operable to perform medium conversion between a first transmission medium and a second transmission medium. The first transmission medium being used for connection with the first interconnecting apparatus and the second transmission medium being different from the first transmission medium in a physical layer.

The second interconnecting apparatus may include a second interconnecting unit operable to interconnect communication between a first transmission medium, which is used for connection with the first interconnecting apparatus, and a second transmission medium; and a first interconnection prohibit unit operable, in a case where receiving of transmission from the first transmission medium or the second transmission medium is disconnected, to disconnect transmission to the first transmission medium and the second transmission medium by the second interconnecting unit.

The first management apparatus may include a monitoring unit that determines whether or not communication between the first interconnecting apparatus and the second interconnecting apparatus is disconnected; an interconnection resume unit operable to release the disconnection of transmission to the second transmission medium by the first interconnection prohibit unit, in a case where communication between the first interconnecting apparatus and the second interconnecting apparatus is disconnected; a management message transmit unit operable to transmit a communication status get message, which is to be sent to a communication device connected to the second interconnection apparatus via the second transmission medium, for getting a communication status of the communication device, in a case where the interconnection resume unit released the disconnection of transmission to the second transmission medium by the first interconnection prohibit unit; and a reply message receive unit operable to receive, from the communication device, a communication status reply message that is a reply to the communication status get message.

The management message transmit unit may transmit the communication status get message to the second interconnecting apparatus, and the second interconnecting apparatus may transmit, to the communication device, the communication status get message received from the management message transmit unit.

The management message transmit unit may transmit the communication status get message to the first interconnecting apparatus; the first interconnecting unit in the first interconnecting apparatus may transmit, to the second interconnecting apparatus, the communication status get message received from the management message transmit unit; and the second interconnecting unit in the second interconnecting apparatus may transmit, to the communication device, the communication status get message received from the first interconnecting unit.

The communication system may further include a third interconnecting apparatus, connected to the second interconnecting apparatus, and a second management apparatus, connected to the first management apparatus, operable to manage the third interconnecting apparatus. The second management apparatus includes a second management command receive unit operable to receive, from the first management apparatus, a management command for managing the third interconnecting apparatus.

The second interconnecting apparatus may include a second interconnecting unit operable to perform medium conversion between a first transmission medium, used for connection with the first interconnecting apparatus, and a second transmission medium different from the first transmission medium in a physical layer; and the third interconnecting apparatus may include a third interconnecting unit operable to perform medium conversion between the second transmission medium, used for connection with the second interconnecting apparatus, and a third transmission medium different from the second transmission medium in a physical layer.

The communication system may further include a third interconnecting apparatus, which is connected to the second interconnecting apparatus, and is operable to perform medium conversion between the second transmission medium, used for connection with the second interconnecting apparatus, and a third transmission medium, different from the second transmission medium in a physical layer. The third interconnecting apparatus includes an interconnection prohibit unit operable to disconnect transmission to the second transmission medium and the third transmission medium, in a case where receiving of transmission from the second transmission medium or the third transmission medium is disconnected; a management message receive unit operable to receive, from the second transmission medium, a communication status get message for getting a communication status of a communication path having the second transmission medium, the third interconnecting apparatus and the third transmission medium; a management message convert unit operable to change a part of the communication status get message to information indicating a communication status of the third interconnecting apparatus, to generate a communication status reply message having a same length as the communication status get message; and a management message reply unit operable to transmit the communication status reply message, via the second transmission medium, to be sent to the first management apparatus, in a case where the interconnection prohibit unit disconnected the transmission to the third transmission medium.

The communication status get message may be an echo message in ICMP (Internet Control Message Protocol), the communication status reply message may be an echo reply message in ICMP, and the management message convert unit may change the part of fields of the echo message, that is the communication status get message, to the information indicating the communication status of the third interconnecting apparatus by exchanging a source IP address and a destination IP address in an IP header of the echo message for each other.

According to a second aspect of the present invention, an interconnecting apparatus, for connecting a first transmission medium and a second transmission medium to each other, includes an interconnection prohibit unit operable to disconnect transmission to the second transmission medium, in a case where a predetermined condition is satisfied; a management message receive unit operable to receive a communication status get message, for getting a communication status of a communication path containing the first transmission medium, the interconnecting apparatus and the second transmission medium, via the first transmission medium; a management message convert unit operable to change a part of fields of the communication status get message to information indicating a communication status of the interconnecting apparatus, to generate a communication status reply message having a same length as the communication status get message; and a management message reply unit operable, in a case where the transmission to the second transmission medium is disconnected, to send back the communication status reply message, via the first transmission medium.

The second transmission medium may be different from the first transmission medium in a physical layer, and the interconnecting apparatus may further include an interconnecting unit operable to perform medium conversion between the first transmission medium and the second transmission medium.

The communication status get message may be an echo message in ICMP (Internet Control Message Protocol), the communication status reply message may be an echo reply message in ICMP, and the management message convert unit may change the part of the fields of the echo message, that is the communication status get message, to the information indicating the communication status of the interconnecting apparatus by exchanging a source IP address and a destination IP address in an IP header of the echo message for each other.

According to a third aspect of the present invention, a communication system management method is provided for managing a communication system including a first interconnecting apparatus connected to an external network; a second interconnecting apparatus connected to the first interconnecting apparatus; and a management apparatus operable to manage the second interconnecting apparatus. The management apparatus may be connected to the first interconnecting apparatus and the second interconnecting apparatus; the first interconnecting apparatus may receive a management command, that is an instruction for management of the second interconnecting apparatus from the external network, and transmit the management command to the management apparatus, and the management apparatus may receive the management command from the first interconnecting apparatus.

According to a fourth aspect of the present invention, an interconnecting apparatus controlling method is provided for controlling an interconnecting apparatus that connects a first transmission medium and a second transmission medium to each other. The method includes disconnecting transmission to the second transmission medium, in a case where a predetermined condition is satisfied; receiving a communication status get message, via the first transmission medium, for getting a communication status of a communication path containing the first transmission medium, the interconnecting apparatus and the second transmission medium; changing a part of fields of the communication status get message to information indicating a communication status of the interconnecting apparatus to generate a communication status reply message having a same length as the communication status get message; and sending back the communication status reply message, via the first transmission medium, in a case where the transmission to the second transmission medium is disconnected.

According to a fifth aspect of the present invention, a computer program is provided for use with a management apparatus in a communication system including a first interconnecting apparatus connected to an external network and a second interconnecting apparatus connected to the first interconnecting apparatus. The management apparatus is operable to manage the second interconnecting apparatus. The second interconnecting apparatus includes an interconnecting unit operable to interconnect communication between a first transmission medium, used for connection with the first interconnecting apparatus, and a second transmission medium; and an interconnection prohibit unit operable to disconnect transmission to the first transmission medium and the second transmission medium by the interconnecting unit, in a case where receiving of transmission from the first transmission medium or the second transmission medium is disconnected. The program enables the management apparatus to operate as a monitoring unit operable to monitor whether or not communication between the first interconnecting apparatus and the second interconnecting apparatus is disconnected; an interconnection resume unit operable, in a case where the communication between the first interconnecting apparatus and the second interconnecting apparatus is disconnected, to release the disconnection of transmission to the second transmission medium by the interconnection prohibit unit; a management message transmit unit operable, in a case where the interconnection resume unit released the disconnection of transmission to the second transmission medium by the interconnection prohibit unit, to transmit a communication status get message, for getting a communication status of a communication device connected to the second interconnecting apparatus via the second transmission medium, to be sent to the communication device; and a reply message receive unit operable to receive a communication status reply message, that is a reply to the communication status get message, from the communication device.

According to a sixth aspect of the present invention, a computer-readable recording medium is provided that contains a program stored therein for use with a management apparatus in a communication system including a first interconnecting apparatus connected to an external network and a second interconnecting apparatus connected to the first interconnecting apparatus. The management apparatus is operable to manage the second interconnecting apparatus and the second interconnecting apparatus includes an interconnecting unit operable to interconnect communication between a first transmission medium, used for connection with the first interconnecting apparatus, and a second transmission medium; and an interconnection prohibit unit operable to disconnect transmission to the first transmission medium and the second transmission medium by the interconnecting unit, in a case where receiving of transmission from the first transmission medium or the second transmission medium is disconnected. The program enables the management apparatus to operate as a monitoring unit operable to monitor whether or not communication between the first interconnecting apparatus and the second interconnecting apparatus is disconnected; an interconnection resume unit operable, in a case where the communication between the first interconnecting apparatus and the second interconnecting apparatus is disconnected, to release the disconnection of transmission to the second transmission medium by the interconnection prohibit unit; a management message transmit unit operable, in a case where the interconnection resume unit released the disconnection of transmission to the second transmission medium by the interconnection prohibit unit, to transmit a communication status get message, for getting a communication status of a communication device connected to the second interconnecting apparatus via the second transmission medium, to be sent to the communication device; and a reply message receive unit operable to receive a communication status reply message, that is a reply to the communication status get message, from the communication device.

The summary of the invention does not necessarily describe all necessary features of the present invention. The present invention may also be a sub-combination of the features described above. The above and other features and advantages of the present invention will become more apparent from the following description of the embodiments taken in conjunction with the accompanying drawings.

### BRIEF DESCRIPTION OF DRAWINGS

FIG. 1 shows an exemplary structure of a global communication system 100 according to an embodiment of the present invention.

FIG. 2 shows an exemplary structure of an interconnecting apparatus 140 according to an embodiment of the present invention.

FIG. 3 shows a structure of a media converter 150a according to an embodiment of the present invention.

FIG. 4 shows an exemplary communication status holding unit 320, in the form of a table, according to an embodiment of the present invention.

FIG. 5 shows a structure of a management apparatus 180 according to an embodiment of the present invention.

FIG. 6 is a sequence of a monitoring operation for media converters 150a and 150c by management apparatuses 180 and 190 according to an embodiment of the present invention.

FIG. 7 shows a structure of a media converter 160a according to an embodiment of the present invention.

FIG. 8 shows a structure of an MC interconnecting unit 710, shown in FIG. 7, according to an embodiment of the present invention.

FIG. 9 shows exemplary formats of a communication status get message and a communication status reply message according to an embodiment of the present invention.

FIG. 10 shows a sequence of a trouble inspecting operation for media converters 150b and 160a by management apparatus 180 according to an embodiment of the present invention.

FIG. 11 shows a sequence of a trouble inspecting operation for media converters 160b and 160c by management apparatus 180 according to an embodiment of the present invention.

FIG. 12 shows an exemplary hardware configuration of management apparatus 180 of an embodiment of the present invention.

### DETAILED DESCRIPTION

The invention will now be described based on preferred embodiments of the invention, which do not intend to limit the scope of the present invention, but exemplify the invention. All of the features and the combinations thereof described in the embodiments are not necessarily essential to the invention.

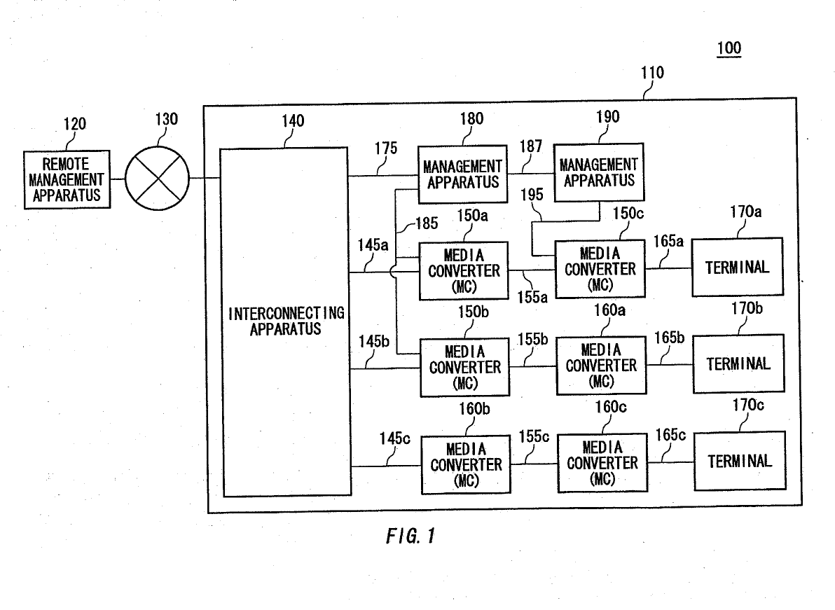

FIG. 1 shows an exemplary structure of a global communication system 100 according to an embodiment of the present invention. The global communication system 100 of the present embodiment includes a communication system 110, a remote management apparatus 120 and a network 130.

The communication system 110 is a network system, for example, in a building having a plurality of offices therein, an apartment building, and the like, which have a plurality of communication devices such as interconnecting devices, terminals or the like, and the network system is formed by connecting these communication devices. The communication system 110 includes an interconnecting apparatus 140, media converters 150a, 150b, 150c, 160a, 160b and 160c, terminals 170a, 170b and 170c and management apparatuses 180 and 190.

The remote management apparatus 120 manages the communication system 110. In the management of the communication system 110, the remote management apparatus 120 transmits to the management apparatuses 180 and 190 a management command for instructing the management apparatuses 180 and 190 in the communication system 110 to manage the communication system 110, thereby making the management apparatuses 180 and 190 execute the management command. The remote management apparatus 120 of the present embodiment transmits a communication status get command for getting a communication status of each communication device in the communication system 110 as such a management command to the management apparatus 180 or 190 in the communication system 110.

When receiving the communication status get command, the management apparatus 180 or 190 in the communication system 110 transmits as a reply a communication status reply command containing information indicative of the communication status in the communication system 10, to the remote management apparatus 120. The remote management apparatus 120 gets the communication status of the communication system 110 and the like in response to the communication status get command. The communication system 110 and the remote management apparatus 120 may support a management command for instructing the management apparatus 180 or 190 to test the communication devices in the communication system 110, for example, in addition to the communication status get command.

Moreover, the communication system 110 and the remote management apparatus 120 may realize the management command by using SET REQUEST message, GET REQUEST message of SNMP (Simple Network Management Protocol) or the like. Furthermore, in a case where trouble occurs in the communication in the communication system 110, for example, the management apparatus 180 or 190 in the communication system 110 may notify the remote management apparatus 120 that trouble has occurred by using a trap message of SNMP.

The network 130 connects the communication system 110 and the remote management apparatus 120 to each other. The network 130 may be a public communication network, such as the Internet or a public telephone line, or any other network, or combinations thereof.

Next, the structure of the communication system 110 according to the present embodiment is described in more detail. As already described above, the communication system 110 includes an interconnecting apparatus 140, media converters 150a, 150b, 150c, 160a, 160b and 160c, terminals 170a, 170b and 170c and management apparatuses 180 and 190.

The media converters 150a, 150b and 160b of the present embodiment are exemplary interconnecting devices according to the present invention. The media converters 150c, 160a and 160c are further exemplary interconnecting devices and/or communication devices according to the present invention. The terminals 170a, 170b and 170c according to the present embodiment are further exemplary communication devices according to the present invention. UTP cables 145a, 145b and 145c according to the present embodiment are exemplary transmission media according to the present invention. UTP cables 165a, 165b and 165c are further exemplary transmission media according to the present invention. The media converters 150a, 150b and 150c and/or the media converters 160a, 160b and 160c may be replaced with interconnecting devices for interconnecting communication between two transmission media, such as repeaters, hub, switches, routers or gateways.

The interconnecting apparatus 140 is connected to the network 130. The interconnecting apparatus 140 may be a hub, a switch, a router or a gateway, for example, or a combination thereof.

A communication path for connecting the interconnecting apparatus 140 and the terminal 170a includes the media converters 150a and 150c.

The media converter 150a is connected to the interconnecting apparatus 140, and performs media conversion between the UTP cable 145a used for connection with the interconnecting apparatus 140 and an optical fiber 155a that is a transmission medium having a different physical layer from that of the UTP cable 145a. The media converter 150a is also connected to the management apparatus 180 via an exclusive cable 185, so as to be managed by the management apparatus 180.

The media converter 150c is connected to the media converter 150a, and performs media conversion between the optical fiber 155a used for connection with the media converter 150a and the UTP cable 165a that is a transmission medium having a different physical layer from that of the optical fiber 155a. The media converter 150c is also connected to the management apparatus 190, so as to be managed by the management apparatus 190.

A communication path for connecting the interconnecting apparatus 140 and the terminal 170b includes the media converters 150b and 160a.

The media converter 150b is connected to the interconnecting apparatus 140, and performs media conversion between the UTP cable 145b used for connection with the interconnecting apparatus 140 and an optical fiber 155b that is a transmission medium having a different physical layer from that of the UTP cable 145b. The media converter 150b is also connected to the management apparatus 180 via the exclusive cable 185, so as to be managed by the management apparatus 180.

The media converter 160a is connected to the media converter 150b, and performs media conversion between the optical fiber 155b used for connection with the media converter 150b and the UTP cable 165b that is a transmission medium having a different physical layer from that of the optical fiber 155b. The media converter 160a has no port for being connected to a management apparatus and therefore is managed by the management apparatus 180 via the media converter 150b.

A communication path for connecting the interconnecting apparatus 140 and the terminal 170c includes the media converters 160b and 160c.

The media converter 160b is connected to the interconnecting apparatus 140, and performs media conversion between the UTP cable 145c used for connection with the interconnecting apparatus 140 and an optical fiber 155c that is a transmission medium having a different physical layer from that of the UTP cable 145c. The media converter 160b has no port for being connected to a management apparatus and therefore is managed by the management apparatus 180 via the interconnecting apparatus 140.

The media converter 160c is connected to the media converter 160b, and performs media conversion between the optical fiber 155c used for connection with the media converter 160b and the UTP cable 165c that is a transmission medium having a different physical layer from that of the optical fiber 155c. The media converter 160c has no port for being connected to a management apparatus and therefore is managed by the management apparatus 180 via the interconnecting apparatus 140 and the media converter 160b.

The terminals 170a, 170b and 170c are connected to the media converters 150c, 160a and 160c, respectively. The terminal 170a performs data transmission and data receiving to/from the network 130 via the interconnecting apparatus 140 and the media converters 150a and 150c. Similarly, the terminal 170b performs data transmission and data receiving to/from the network 130 via the interconnecting apparatus 140 and the media converters 150b and 160a, while the terminal 170c performs them via the interconnecting apparatus 140 and the media converters 160b and 160c.

In the present embodiment, for convenience of explanation, it is assumed that the UTP cables 145a, 145b and 145c and the UTP cables 165a, 165b and 165c are based on 100 BASE-TX while the optical fibers 155a, 155b and 155c are based on 100 BASE-FX. Instead, the UTP cables 145a, 145b and 145c, the optical fibers 155a, 155b and 155c and the UTP cables 165a, 165b and 165c may be transmission media based on other Ethernet specification or the like.

The management apparatus 180 is connected to the interconnecting apparatus 140 and the media converters 150a and 150b, and manages the media converters 150a, 150b, 160a, 160b and 160c. The management apparatus 180 according to the present embodiment receives a management command from the remote management apparatus 120 via the interconnecting apparatus 140 and then manages the media converters 150a, 150b, 160a, 160b and 160c in accordance with the instruction indicated by the management command.

The management apparatus 190 is connected to the management apparatus 180 and manages the media converter 150c. The management apparatus 190 according to the present embodiment receives a management command from the management apparatus 180 and then manages the media converter 150c in accordance with the instruction indicated by the received management command.

More specifically, when receiving a management command that instructs the management apparatuses 180 and 190 to manage the communication devices in the communication system 110, the management apparatuses 180 and 190 perform a management operation for the corresponding communication devices that are to be managed by the management apparatuses 180 and 190 in accordance with the instruction indicated by the management command. Each of the management apparatuses 180 and 190 transmits a management message to the communication device to be managed, that is, the target communication device. Each of the management apparatuses 180 and 190 supports, as the management message, a communication status get message for getting a communication status of the communication device to be managed, and an interconnection set message, for example, for permitting or prohibiting interconnection by the media converters 150a to 150c or 160a to 160c. The management apparatus 180 and/or the management apparatus 190 may realize the management message by using SET REQUEST message and GET REQUEST message of SNMP (Simple Network Management Protocol), for example. In a case where trouble has occurred in the communication device to be managed, the occurrence of the trouble or the like may be notified to the remote management apparatus 120 by using a trap message of SNMP, for example.

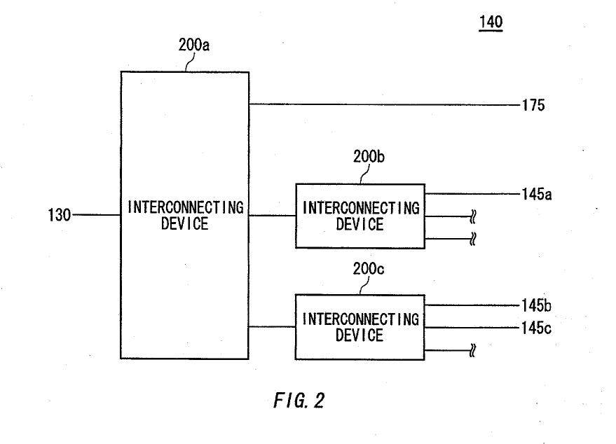

FIG. 2 shows an exemplary structure of the interconnecting apparatus 140 according to an embodiment of the present invention. The interconnecting apparatus 140 of the present embodiment includes interconnecting devices 200a, 200b and 200c. The combination of the interconnecting devices 200a, 200b and 200c is an example of an interconnecting unit according to the present invention.

The interconnecting device 200a is an interconnecting device, such as a router or a gateway, that connects the network 130, a UTP cable 175, the interconnecting device 200b and the interconnecting device 200c to one another. The interconnecting device 200a receives a management command that instructs to manage the media converters 150a, 150b and 150c and the media converters 160a, 160b and 160c from the remote management apparatus 120, and then transmits it to the management apparatus 180, via the UTP cable 175. The interconnecting device 200b is an interconnecting device, such as a switch or a router, for connecting the interconnecting device 200a to the UTP cable 145a. The interconnecting device 200c is an interconnecting device, such as a switch or a router, for connecting the interconnecting device 200a, the UTP cable 145b and the UTP cable 145c to one another.

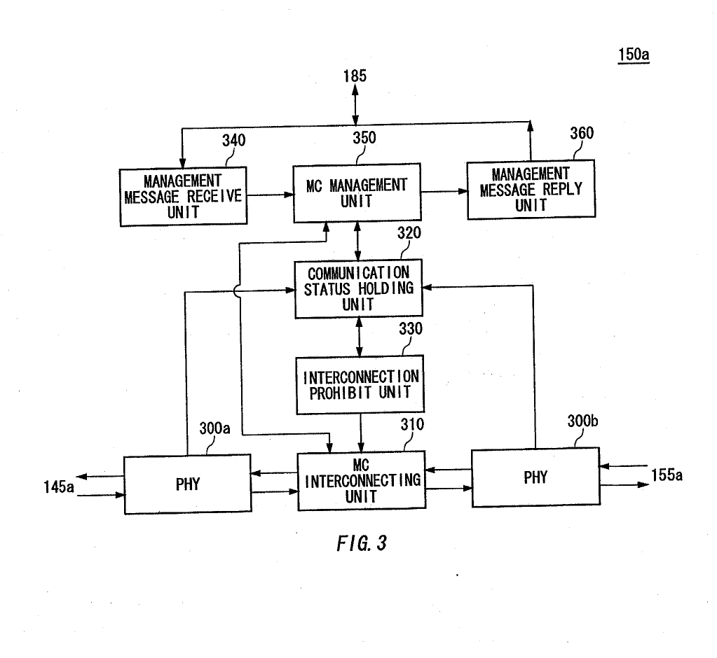

FIG. 3 shows an exemplary structure of the media converter 150a according to an embodiment of the present invention. Since the media converters 150b and 150c have substantially the same structure as the media converter 150a, further description thereof is omitted.

The media converter 150a includes physical layer devices or PHYs 300a, 300b, an MC interconnecting unit 310, a communication status holding unit 320, an interconnection prohibit unit 330, a management message receiving unit 340, an MC management unit 350 and a management message reply unit 360. The combination of the PHY 300a, the PHY 300b and the MC interconnecting unit 310 serves as a further exemplary interconnecting unit in an interconnecting apparatus according to the present invention.

The PHY 300a connects the UTP cable 145a that is based on 100 BASE-TX specification to the MC interconnecting unit 310. The PHY 300a performs conversion between the UTP cable 145a and MII (Media Independent Interface) based on IEEE802.3, and is connected to the MC interconnecting unit 310 via MII.

The PHY 300b connects the optical fiber 155a that is based on 100 BASE-FX specification to the MC interconnecting unit 310. The PHY 300b performs conversion between the optical fiber 155a and MII based on IEEE802.3, and is connected to the MC interconnecting unit 310 via MII.

The MC interconnecting unit 310 interconnects the communication between the PHY 300a and the PHY 300b. The MC interconnecting unit 310 also prohibits the communication between the PHYs 300a and 300b in accordance with an instruction from the interconnection prohibit unit 330. Moreover, the MC interconnecting unit 310 transmits a message for management that is input from the MC management unit 350 to another communication device via the PHY 300a or 300b, and outputs another message for management received from the other communication device to the MC management unit 350. The MC interconnecting unit 310 of the present embodiment does not prohibit the interconnection of the reply message responding to the management message even in a case where the communication between the PHYs 300a and 300b is prohibited. Thus, the media converter 150a can transfer the reply message to the management apparatus 180 even if the prohibition of the interconnection of the communication is set.

The PHY 300a, the PHY 300b and the MC interconnecting unit 310 interconnect the communication between the UTP cable 145a used for connection with the interconnecting apparatus 140 and the optical fiber 155a. Also, the PHY 300a, the PHY 300b and the MC interconnecting unit 310 perform media conversion between the UTP cable 145a used for connection with the interconnecting apparatus 140 and the optical fiber 155a that is a transmission medium having a different physical layer from that of the UTP cable 145a.

The communication status holding unit 320 acquires the communication status of each of the PHYs 300a and 300b and holds the acquired status for each PHY. The communication status holding unit 320 may hold information indicating the presence or absence of trouble in the media converter 150a, in addition to the communication status of each of the PHYs 300a and 300b.

The interconnection prohibit unit 330 refers to the information related to the communication status for each PHY held by the communication status holding unit 320, so that it controls the MC interconnecting unit 310 to permit or prohibit the interconnection between the UTP cable 145a and the optical fiber 155a. More specifically, the interconnection prohibit unit 330 disconnects the transmission to the UTP cable 145a by the PHY 300a and the transmission to the optical fiber 155a by the PHY 300b in a case where the receiving from the UTP cable 145a or the optical fiber 155a is disconnected. The PHY 300a realizes the disconnection for the UTP cable 145a by prohibiting the data transmission to the UTP cable 145a and the transmission of an idle signal in a case where no data is transmitted. The PHY 300b also realize the disconnection for the optical fiber 155a in a similar manner to the PHY 300a.

The management message receive unit 340 receives a management message transmitted from the management apparatus 180.

The MC management unit 350 performs the management work based on the management message received by the management message receive unit 340. More specifically, in a case where the management message receive unit 340 received a communication status get message for the media converter 150a, the MC management unit 350 gets the communication status of the media converter 150a from the communication status holding unit 320 so as to generate a communication status reply message, and then transmits the generated communication status reply message to the management apparatus 180 via the management message reply unit 360. In another case where the management message receive unit 340 received an interconnection setting message for the media converter 150a, the MC management unit 350 sets permission or prohibition of the interconnection by the PHY 300a and/or the PHY 300b in the information indicating the communication status stored in the communication status holding unit 320, thereby permitting or prohibiting the interconnection by the interconnection prohibit unit 330. In still another case where a management message other than the management message for the media converter 150a was received, the MC management unit 350 transmits the management message received via the MC interconnecting unit 310 to the UTP cable 145a or the optical fiber 155a, thereby transferring it to the communication device for which the management is to be performed.

The management message reply unit 360 transmits a reply message responding to the management message in accordance with the instruction from the MC management unit 350.

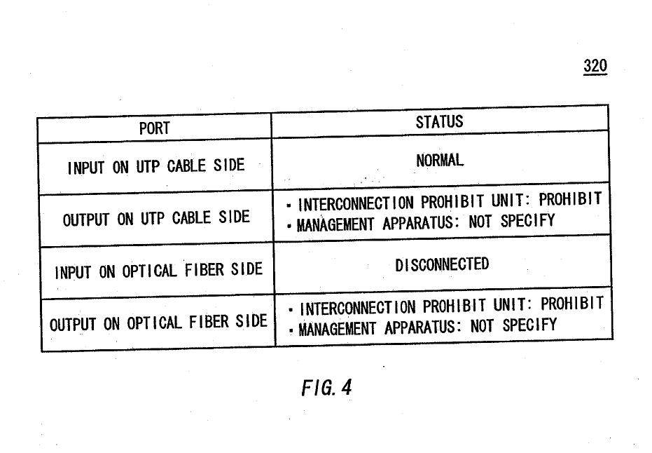

FIG. 4 shows an exemplary communication status holding unit 320 shown in FIG. 3, according to an embodiment of the present invention, in the form of a table. The communication status holding unit 320 according to the present embodiment has a port field and a status field.

The port field is a field for classifying the communication statuses held by the communication status holding unit 320 into ports for performing an input and an output for the media converter 150a. The communication statuses held by the communication status holding unit 320 are classified by the port field into an input port on the UTP cable 145a side, an output port on the UTP cable 145a side, an input port on the optical fiber 155a side, and an output port on the optical fiber 155a side.

The status field is used for holding the communication status at the port specified by the corresponding port field. The communication status holding unit 320 sets, as a value of the status field regarding the input port, “normal” that indicates that a data signal or an idle signal is being received normally or “disconnected” that indicates that the data signal or idle signal is not being received normally. The communication status holding unit 320 also sets, as a value of the status field regarding the output port, permission or prohibition of the transmission by the interconnection prohibit unit 330 and permission, prohibition or not-specified of the transmission by the management apparatus 180. The MC interconnecting unit 310 sets the permission or prohibition of the transmission by the management apparatus 180 prior to specifying the permission or prohibition of the transmission by the interconnection prohibit unit 330.

In FIG. 4, that shows the present embodiment, the receiving from the UTP cable 145a is in the normal state, while the receiving from the optical fiber 155a is in the disconnected state. In this case, the interconnection prohibit unit 330 gets the communication statuses of the UTP cable 145a and the optical fiber 155a from the communication status holding unit 320, thereby detecting that the receiving from the optical fiber 155a is in the disconnected state. Then, the interconnection prohibit unit 330 prohibits the transmission to the UTP cable 145a and the optical fiber 155a, so as to disconnect the transmission thereto. On the other hand, the communication status holding unit 320 sets “not-specify” for the interconnection by the management apparatus 180 since the communication status holding unit 320 received no interconnection setting message or the setting for the interconnection was instructed to be set to be “not-specify”.

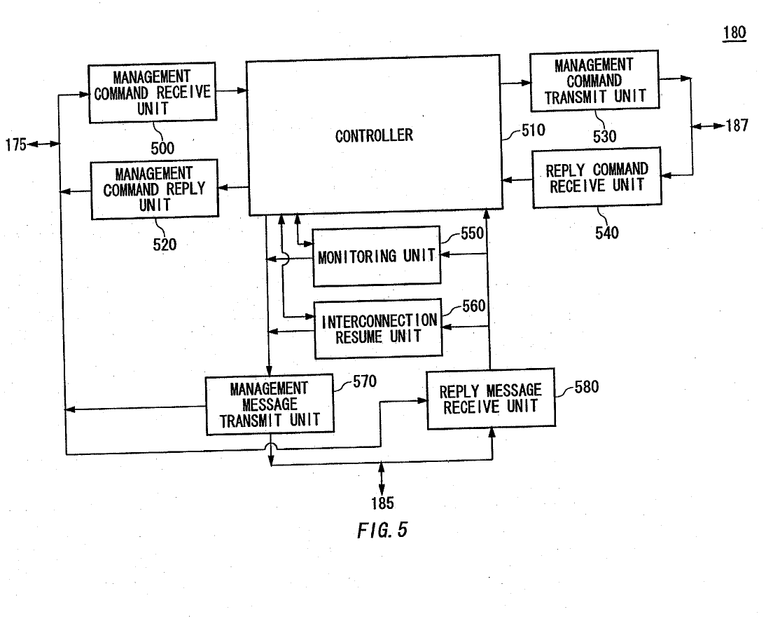

FIG. 5 shows an exemplary structure of the management apparatus 180 according to an embodiment of the present invention. Since the management apparatus 190 has substantially the same structure as the management apparatus 180 a description thereof is omitted. The management apparatus 180 of the present embodiment includes a management command receive unit 500, a controller 510, a management command reply unit 520, a management command transmit unit 530, a reply command receive unit 540, a monitoring unit 550, an interconnection resume unit 560, a management message transmit unit 570, and a reply message receive unit 580.

The management command receive unit 500 receives from the interconnecting apparatus 140 the management command that the remote management apparatus 120 transmitted to the management apparatus 180 and/or the management apparatus 190.

The controller 510 performs the management of the communication device to be managed in accordance with the management command. More specifically, in a case where the communication status get command was received, the management apparatus 180 transmits the communication status get message to the media converters 150a, 150b, 160a, 160b and 160c, thereby getting the communication statuses of these media converters. Also, the management apparatus 180 transfers the communication status get command to the management apparatus 190, thereby making the management apparatus 190 get the communication status of the media converter 150c. The management apparatus 180 then sends back the obtained communication statuses to the remote management apparatus 120 as a communication status reply command. Moreover, the management apparatus 180 transmits the interconnection setting message to the communication devices, if necessary, so that the management apparatus 180 sets the respective communication devices in the communication system 110 so as to allow the communication status get message to reach the communication device to be managed.

The management command reply unit 520 transmits the reply message responding to the management message based on the instruction from the controller 510, to the remote management apparatus 120.

The management command transmit unit 530 transfers the management command to the management apparatus 190 in accordance with the instruction from the controller 510.

The reply command receive unit 540 receives the reply command of the management apparatus 190 that responds to the management command transferred by the controller 510.

The monitoring unit 550 transmits the communication status get message to the media converter 150a, the media converter 150b and/or the media converter 160b regularly, for example, so as to get the communication statuses by receiving the communication status reply message from each of these interconnecting apparatuses. The monitoring unit 550 then monitors whether or not the communication between the interconnecting apparatus 140 and each of the media converter 150a, the media converter 150b and/or the media converter 160b is disconnected. Moreover, if the communication between the interconnecting apparatus 140 and any of the media converter 150a, the media converter 150b and the media converter 160b is disconnected, the monitoring unit 550 notifies the controller 510 of that fact. When receiving this notification, the controller 510 issues a management message to each communication device in the communication system 110, thereby performing a trouble inspecting operation that identifies a position in the communication system 110 where the trouble occurred.

The interconnection resume unit 560 releases a disconnection of the transmission from the media converter 150b to the optical fiber 155b or a disconnection of the transmission from the media converter 160b to the optical fiber 155c in the trouble inspecting operation. For example, the interconnection resume unit 560 transmits the interconnection setting message to the media converter 150b in response to the instruction from the controller 510 so as to make the interconnection prohibit unit 330 in the media converter 150b release a disconnection set by a member. Thus, the controller 510 can transmit the communication status get message for getting the communication status of the media converter 160a to the media converter 160a, via the optical fiber 155b.

The management message transmit unit 570 transmits a management message, that the controller 510, the monitoring unit 550, or the interconnection resume unit 560 is to transmit to the media converter 150a, 150b or 160b, to the UTP cable 175 or the exclusive cable 185.

The reply message receive unit 580 receives the reply message responding to the management message that was transmitted by the controller 510, the monitoring unit 550 or the interconnection resume unit 560, via the management message transmit unit 570, or the like.

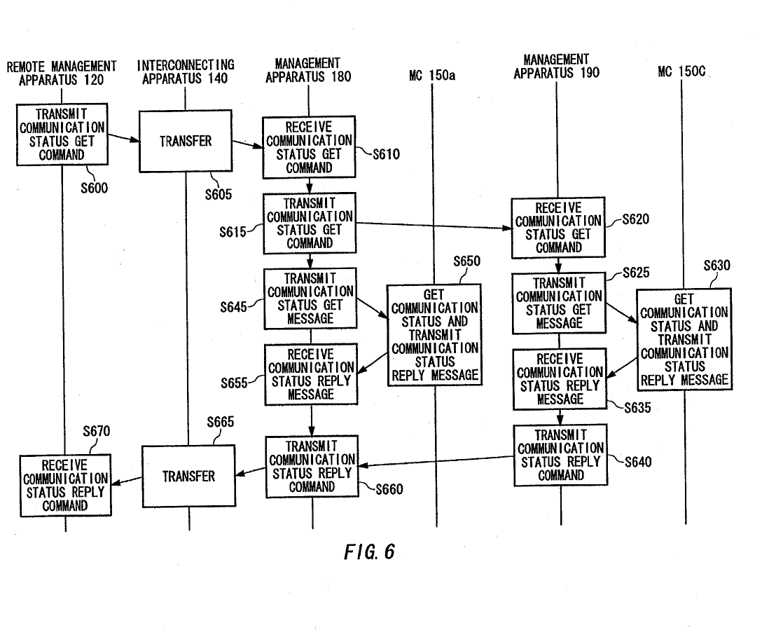

FIG. 6 shows an exemplary sequence of the monitoring operation for the media converters 150a and 150c by the management apparatuses 180 and 190 according to an embodiment of the present invention.

The remote management apparatus 120 transmits a communication status get command to the interconnecting apparatus 140, via the network 130 (Step S600). The interconnecting apparatus 140 then transmits the communication status get command, received from the remote management apparatus 120, to the management apparatus 180, via the UTP cable 175 (Step S605). The management command receive unit 500 in the management apparatus 180 receives the communication status get command from the interconnecting apparatus 140 (Step S610).

When receiving the communication status get command, the controller 510 in the management apparatus 180 transmits the communication status get command for getting the communication status of the media converter 150c, which is managed by the management apparatus 190, to the management apparatus 190, via the management command transmit unit 530 (Step S615). The management apparatus 190 receives the communication status get command that the management apparatus 180 transmitted, via the UTP cable 187 (Step S620). The management apparatus 190 then transmits a communication status get message in order to get the communication status of the media converter 150c (Step S625).

When receiving the communication status get message from the management apparatus 190, via the management message receive unit 340, the MC management unit 350 in the media converter 150c gets the communication status from the communication status holding unit 320 in the media converter 150c so as to generate a communication status reply message, and transmits the generated communication status reply message to the management apparatus 190, via the management message reply unit 360 (Step S630). The management apparatus 190 receives the communication status reply message from the media converter 150c (Step S635), and sends back a communication status reply command, that is a response to the communication status get command received from the management apparatus 180, to the management apparatus 180 (Step S640). The communication status reply command transmitted by the management apparatus 190 in Step S640 contains information indicating the communication status of the media converter 150c.

Moreover, after Step S615, the management apparatus 180 transmits a communication status get message to the media converter 150a, via the management message transmit unit 570, in order to get the communication status of the media converter 150a (Step S645).

When receiving the communication status get message from the management apparatus 180, via the management message receive unit 340, the MC management unit 350 in the media converter 150a gets the communication status from the communication status holding unit 320 in the media converter 150a so as to generate a communication status reply message, and transmits the generated communication status reply message to the management apparatus 180, via the management message reply unit 360 (Step S650). The controller 510 in the management apparatus 180 receives the communication status reply message from the media converter 150a, via the reply message receive unit 580 (Step S655), and sends back the communication status reply command, that is the response to the communication status get command received from the remote management apparatus 120, to the interconnecting apparatus 140, via the management command reply unit 520 (Step S660). The communication status reply command transmitted by the management apparatus 180 in Step S660 contains information indicating the communication status of the media converter 150a and the information indicating the communication status of the media converter 150c that was received from the management apparatus 190.

The interconnecting apparatus 140 transmits the communication status reply command to the remote management apparatus 120 through the network 130 (Step S665). As a result of the above operations, the remote management apparatus 120 receives the communication status reply command (Step S670).

As described above, the management apparatuses 180 and 190 according to the present embodiment can perform the monitoring operation for the media converters 150a and 150c by cooperation with each other. The management apparatuses 180 and 190 can perform the monitoring operation for the corresponding media converters 150a and 150c by respectively using the cables 185 and 195 for management, that are different paths from the communication path between the interconnecting apparatus 140 and the terminal 170a. Thus, even in a case where trouble occurs in the communication path between the interconnection apparatus 140 and the terminal 170a, it is possible to manage the media converters 150a and 150c. Moreover, the management apparatus 180 receives the management command from the remote management apparatus 120 and then instructs the management apparatus 190 to perform the management. Thus, the remote management apparatus 120 can manage the communication devices of the communication system 100 by simply instructing the management apparatus 180 to perform the management of the communication system.

In a case where there are a plurality of communication paths that are substantially the same as the communication path formed by the media converters 150a and 150c, the management apparatus 180 may manage a plurality of interconnecting apparatuses corresponding to the media converter 150a in the plurality of communication paths while the management apparatus 190 manages a plurality of interconnecting apparatuses corresponding to the media converter 150c.

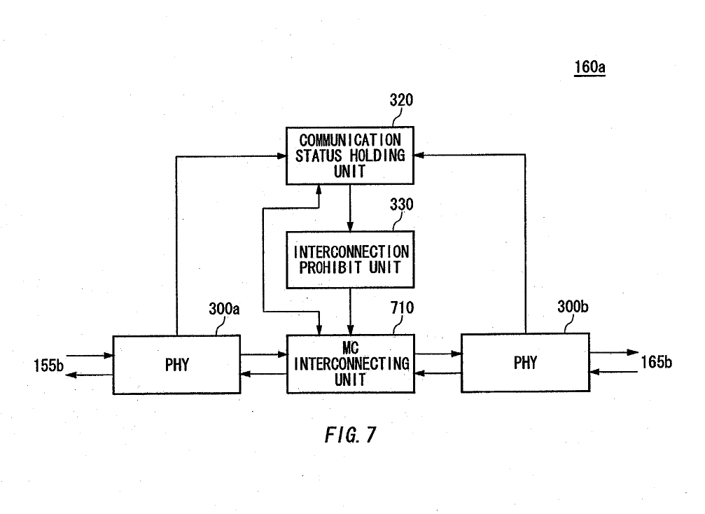

FIG. 7 shows an exemplary structure of the media converter 160a according to an embodiment of the present invention. The media converters 160b and 160c have substantially the same structure as the media converter 160a, and therefore a description thereof is omitted.

The media converter 160a according to the present embodiment includes a PHY 300a, a PHY 300b, a communication status holding unit 320, an interconnection prohibit unit 330 and an MC interconnecting unit 710.

The PHYs 300a and 300b, the communication status holding unit 320 and the interconnection prohibit unit 330 in the media converter 160a have substantially the same functions as the PHYs 300b and 300a, the communication status holding unit 320, and the interconnection prohibit unit 330 in the media converter 150a, respectively.

The MC interconnecting unit 710 interconnects the communication between the PHYs 300a and 300b. Also, the MC interconnecting unit 710 prohibits the communication between the PHYs 300a and 300b based on the instruction by a prohibit setting message from the management apparatus 180 and/or the instruction from the interconnection prohibit unit 330. Moreover, in a case where the transmission from the PHY 300b is prohibited, the MC interconnecting unit 710 converts the communication status get message received from the PHY 300a and sends back the converted message as the communication status reply message, via the PHY 300a. Similarly, in a case where the transmission from the PHY 300a is prohibited, the MC interconnecting unit 710 converts the communication status get message received from the PHY 300b and sends back the converted message as the communication status reply message, via the PHY 300b.

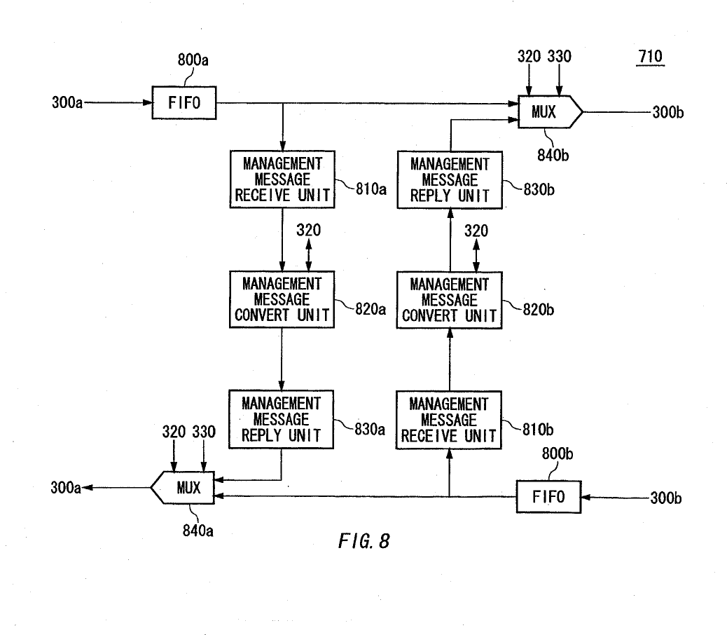

FIG. 8 shows an exemplary structure of the MC interconnecting unit 710, in FIG. 7, according to an embodiment of the present invention. The MC interconnecting unit 710 of the present embodiment includes a FIFO cue 800a, a FIFO cue 800b, a management message receive unit 810a, a management message receive unit 810b, a management message convert unit 820a, a management message convert unit 820b, a management message reply unit 830a, a management message reply unit 830b, a multiplexer 840a and a multiplexer 840b. The PHYs 300a and 300b, the FIFO cues 800a and 800b and the multiplexers 840a and 840b are an example of an interconnecting unit according to the present invention.

The FIFO cue 800a, the management message receive unit 810a, the management message convert unit 820a, the management message reply unit 830a, and the multiplexer 840a have the substantially the same structure as the FIFO cue 800b, the management message receive unit 810b, the management message convert unit 820b, the management message reply unit 830b, and the multiplexer 840b, respectively. Therefore, in the present embodiment, only the FIFO cue 800a, the management message receive unit 810a, the management message convert unit 820a, the management message reply unit 830a, and the multiplexer 840a are described.

The FIFO cue 800a is a First-In-First-Out buffer for temporarily storing a packet received from the PHY 300a. The management message receive unit 810a gets a management message received by the FIFO cue 800a and transfers it to the management message convert unit 820a. When receiving the management message from the management message receive unit 810a, the management message convert unit 820a processes the received management message in a manner corresponding to the management message and also generates a reply message to the management message. In this generation, the management message convert unit 820a generates a reply message having the same length as that of the management message by changing parts of fields of the management message. The management message reply unit 830a transmits the reply message thus generated by the management message convert unit 820a to the multiplexer 840a. The multiplexer 840a selects which one of a packet input from the FIFO cue 800b, received via the UTP cable 165b and the PHY 300b, and the reply message transmitted from the management message reply unit 830a is to be output to the PHY 300a. The multiplexer 840a of the present embodiment outputs the reply message transmitted from the management message reply unit 830a to the PHY 300a, in a case where the transmission to the UTP cable 165b is prohibited by the management apparatus 180 or in a case the transmission to the UTP cable 165b is prohibited by the interconnection prohibit unit 330.

The MC interconnecting unit 710 of the present embodiment is arranged so as not to prohibit the interconnection of the reply message responding to the management message even in a case where the communication between the PHYs 300a and 300b is prohibited. Thus, the media converter 160a can transfer the reply message to the management apparatus 180 irrespective of the prohibition of the interconnection.

As described above, the management message reply unit 830a sends back the reply message, such as the communication status reply message, via the optical fiber 155b, in a case where the transmission to the UTP cable 165b is disconnected. Thus, the media converter 160a can operate as a part of the transmission medium running from the interconnecting apparatus 140 to the terminal 170b in the normal state and can transmit the reply message responding to the management message from the management apparatus 180 in the disconnected state. Therefore, the media converter 160a can be managed in accordance with the instruction from the management apparatus 180 even in the disconnected state.

In a case where the media converter 160a receives the management message in the normal state, the media converter 160a may transmit the reply message at a timing when the packet is not interconnected from the UTP cable 165b to the optical fiber 155b. Alternatively, in a case where the media converter 160a received the management message in the normal state, the media converter 160a may transmit the reply message after disconnecting the transmission to the UTP cable 165b.

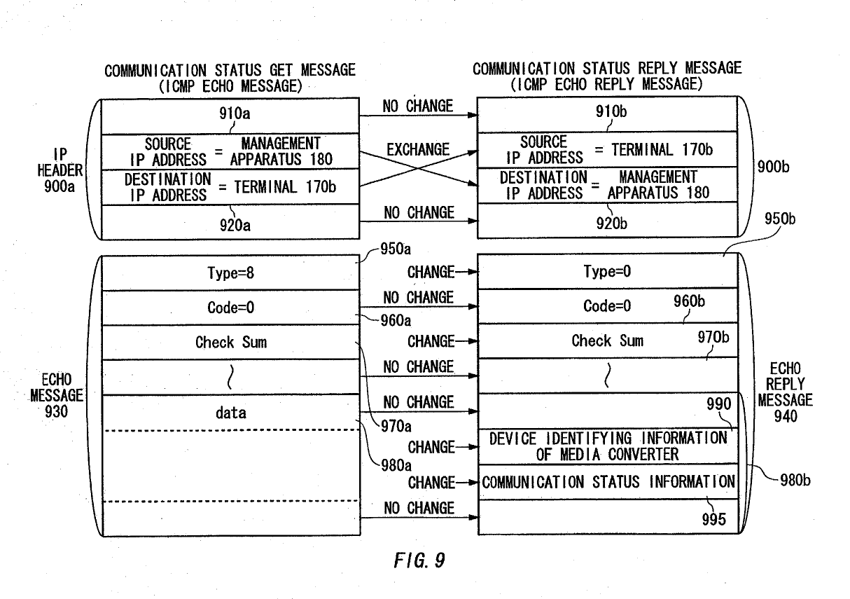

FIG. 9 shows exemplary formats of the communication status get message and communication status reply message according to an embodiment of the present invention. The communication status get message of the present embodiment is an ICMP echo message having an IP header 900a and an echo message field 930.

The IP header 900a is header information necessary for delivering the communication status get message in accordance with IP protocol. The IP header 900a contains a source IP address 910a and a destination IP address 920a. The source IP address 910a holds an IP address that identifies the source of the communication status get message. The destination IP address 920a holds an IP address that identifies the destination of the communication status get message. The source IP address 910a and the destination IP address 920a shown in FIG. 9 indicate that the shown communication status get message is a packet transmitted from the management apparatus 180 to the terminal 170b.

The echo message field 930 holds the contents of the ICMP echo message. The echo message field 930 contains a type field 950a, a code field 960a, a check sum field 970a, and a data field 980a. The data field 980a of the present embodiment is an exemplary data field of an echo message according to the present invention.

The type field 950a and the code field 960a are information for identifying the message type of the ICMP message type. The type field 950a and the code field 960a of the present embodiment indicate that the communication status get message is an ICMP echo message (Type=8, Code=0). The check sum field 970a holds a check sum of the echo message field 930. The data field 980a holds data of the ICMP echo message.

In a case where the transmission to the UTP cable 165b is disconnected, when the media converter 160a receives the communication status get message that the management apparatus 180 transmitted to the terminal 170b, the media converter 160a converts the received communication status get message to the communication status reply message containing information indicating the communication status of the media converter 160a and sends the communication status reply message back to the management apparatus 180. Similarly, when receiving the communication status get message that the management apparatus 180 transmitted to the terminal 170c, in a case where the transmission is disconnected, the media converters 160b and 160c convert the received communication status get message to the communication status reply message containing information indicating the communication status of those interconnecting apparatuses and send the communication status reply message back to the management apparatus 180.

The communication status reply message of the present embodiment is an ICMP echo reply message including an IP header 900b and an echo reply message fields 940.

The IP header 900b is header information necessary for delivering the communication status reply message in accordance with IP protocol. The IP header 900b contains a source IP address 910b and a destination IP address 920b. The source IP address 910b holds an IP address that identifies the source of the communication status reply message. The destination IP address 920b holds an IP address that identifies the destination of the communication status reply message. The source IP address 910b and the destination IP address 920b shown in FIG. 9 indicate that the shown communication status reply message is a packet transmitted from the terminal 170b to the management apparatus 180. The communication status holding unit 320 in the media converter 160a exchanges the source IP address 910a in the IP header 900a of the ICMP echo message serving as the communication status get message for the destination IP address 920a thereof so as to store the IP addresses after the exchange in the source IP address 910b and the destination IP address 920b, respectively, when generating the communication status reply message.

The echo reply message fields 940 holds the contents of the ICMP echo reply message. The echo reply message fields 940 contains a type field 950b, a code field 960b, a check sum field 970b, and a data field 980b. The type field 950b and the code field 960b are information for identifying the message type of the ICMP message type. The type field 950b and the code field 960b of the present embodiment indicate that the communication status reply message is an ICMP echo reply message (Type=0, Code=0). The check sum field 970b holds a check sum of the echo reply message fields 940.

The data field 980b holds data of the ICMP echo reply message. The data field 980b contains device identifying information 990 and communication status information 995. The device identifying information 990 is information for identifying the media converter 160a. The device identifying information may be a device identifying number of a manufacturer uniquely assigned to a product by the manufacturer, for example. The communication status information 995 is information that indicates the communication status of the media converter 160a. The communication status holding unit 320 in the media converter 160a changes a part of the data field 980a of the ICMP echo message serving as the communication status get message to the device identifying information 990 and the communication status information 995 and stores the result of that change in the data field 980b when generating the communication status reply message. Moreover, the communication status holding unit 320 in the media converter 160a generates a check sum that depends on the contents of the changed echo reply message fields 940 and stores the generated check sum in the check sum field 970b.

As described above, in a case where the transmission to the UTP cable 165b is disconnected and the communication status get message transmitted by the management apparatus 180 to be sent to the terminal 170b cannot be transmitted to the UTP cable 165b, the media converter 160a sends back the communication status reply message in place of the terminal 170b. The management apparatus 180 can find the fact that the communication path to the terminal 170b is disconnected at the media converter 160a and the communication status of the media converter 160a based on the device identifying information 990 and the communication status information 995 in the received communication status reply message. The management apparatus 180 can notify the remote management apparatus 120 of the communication status based on these kinds of information or transmit the interruption setting packet to the media converter 160a so as to deal with the disconnection, for example, to release the transmission to the UTP cable 165b. In this manner, the management apparatus 180 can get the communication statuses of the optical fiber 155b, the media converter 160a, the UTP cable 165b and the terminal 170b by using the communication status get message for the terminal 170b. Similarly, the management apparatus 180 can get the communication statuses of the UTP cable 145c, the media converter 160b, the optical fiber 155c, the media converter 160c, the UTP cable 165c and the terminal 170c by using the communication status get message for the terminal 170c.

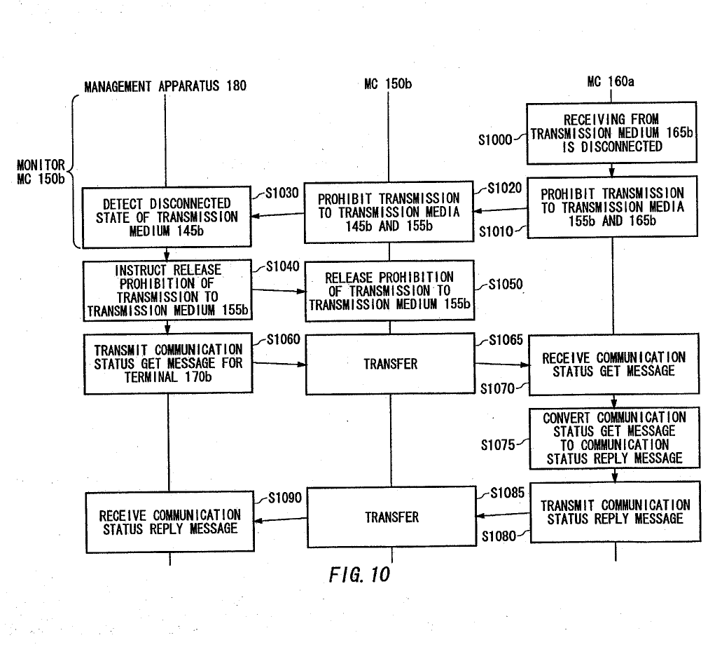

FIG. 10 shows a sequence of the trouble inspecting operation for the media converters 150b and 160a by the management apparatus 180 according to the present embodiment.

First, a trouble has occurred in the UTP cable 165b, thereby the receiving from the UTP cable 165b to the media converter 160a is disconnected (Step S1000). In this case, the interconnection prohibit unit 330 in the media converter 160a prohibits the transmission to the optical fiber 155b and the UTP cable 165b (Step S1010). The communication status holding unit 320 in the media converter 160a stores the communication state that occurred or was set in Steps S1000 and S1010.

Since the transmission to the optical fiber 155b by the media converter 160a is prohibited, the receiving from the optical fiber 155b is disconnected in the media converter 150b. The communication status holding unit 320 in the media converter 150b detects that the receiving from the optical fiber 155b was disconnected. As a result, the interconnection prohibit unit 330 in the media converter 150b prohibits the transmission to the UTP cable 145b and the optical fiber 155b (Step S1020). Then, the monitoring unit 550 in the management apparatus 180 detects the disconnection of the UTP cable 145b (Step S1030).

Then, the interconnection resume unit 560 in the management apparatus 180 transmits the interconnection setting message to the media converter 150b (Step S1040), thereby releasing the prohibition of the transmission to the optical fiber 155b (Step S1050). The controller 510 in the management apparatus 180 then transmits the communication status get message for the terminal 170b, via the management message transmit unit 570 (Step S1060). The media converter 150b transfers the communication status get message that the management apparatus 180 transmitted to the media converter 160a (Step S1065).

Then, the media converter 160a receives the communication status get message transmitted by the management apparatus 180 (Step S1070). The management message convert unit 820a in the media converter 160a converts the communication status get message received, so as to generate the communication status reply message containing the communication status of the media converter 160a (Step S1075). In this generation, the management message convert unit 820a exchanges the source IP address 910a in the IP header 900a of the communication status get message for the destination IP address 920a therein, as shown in FIG. 9, and stores the result of the exchange in the source IP address 910b and the destination IP address 920b of the communication status reply message. Thus, the communication status reply message holds the IP header 900b indicating that it is a packet to be sent to the management apparatus 180 from the terminal 170b. The media converter 160a then transmits the communication status reply message thus generated to the optical fiber 155b (Step S1080). The media converter 150b acquires the communication status reply message and transfers it to the management apparatus 180 (Step S1085). The management apparatus 180 receives the communication status reply message (Step S1090).

As a result of the above operations, the management apparatus 180 can acquire information indicating the communication status of the media converter 160a.

As described above, the management apparatus 180 of the present embodiment can perform the monitoring operation for the media converter 150b, and that for the media converter 160a via the media converter 150b. The management apparatus 180 can perform the monitoring operation for the media converter 150b by using the cable 185 for management, which is a different path from the communication path between the interconnecting apparatus 140 and the terminal 170b. Thus, even in a case where a trouble has occurred in the communication path between the interconnecting apparatus 140 and the terminal 170b, the management apparatus 180 can manage at least the media converter 150b using the cable 185 for management.

Moreover, the management apparatus 180 can manage the media converter 160a through the media converter 150b. Thus, it is not necessary to provide a management apparatus that is connected directly to the media converter 160a. Therefore, it is possible to easily wire cables in a case where the distance between the media converters 150b and 160a is elongated, for example.

In a case where there are a plurality of communication paths that are substantially the same as the communication path formed by the media converters 150b and 160a, the management apparatus 180 may manage a plurality of interconnecting apparatuses corresponding to the media converter 150b, while managing a plurality of interconnecting apparatuses corresponding to the media converter 160a through respective interconnecting apparatuses corresponding to the media converter 150b.

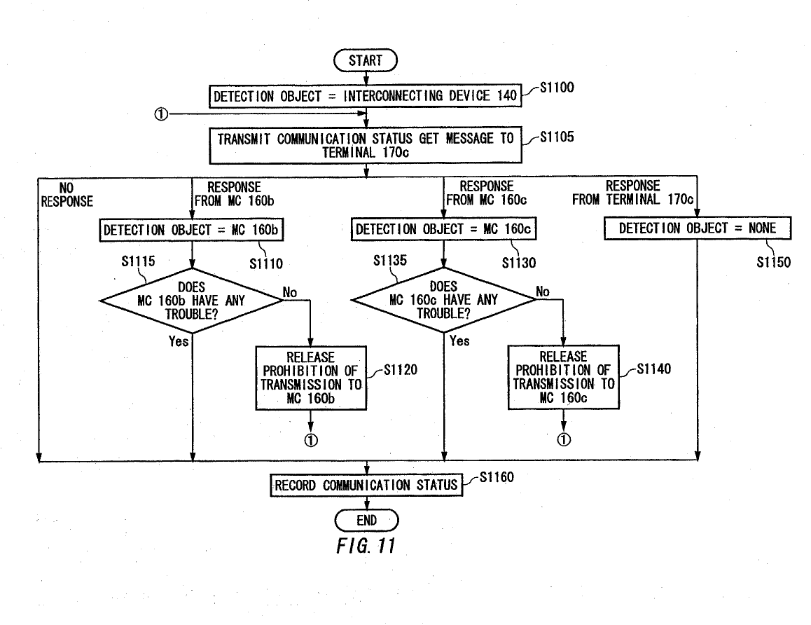

FIG. 11 shows a sequence of the trouble inspecting operation for the media converters 160b and 160c by the management apparatus 180 according to an embodiment of the present invention.

The management apparatus 180 temporarily regards the interconnecting apparatus 140 as a communication device for which the trouble is to be detected by this sequence (Step S1100). Then, the controller 510 in the management apparatus 180 transmits the communication status get message for the terminal 170c, via the management message transmit unit 570 (Step S1105).

Then, depending on the status of the communication between the interconnecting apparatus 140 and the terminal 170c, either one of the following events occurs. The management apparatus 180 does not receive the communication status reply message responding to the communication status get message or the management apparatus 180 receives the communication status reply message from any of the media converters 160b and 160c and the terminal 170c. In a case where the management apparatus 180 does not receive the communication status reply message, the management apparatus 180 considers that the communication device for which the trouble detection is performed has trouble. The management apparatus 180 then records the communication status of that communication device (Step S1160), and this sequence is finished.

When the management apparatus 180 receives the communication status reply message from the media converter 160b, via the reply message receive unit 580, the controller 510 in the management apparatus 180 changes the object of the detection to the media converter 160b (Step S1110). Then, the controller 510 in the management apparatus 180 acquires the communication status of the media converter 160b stored in the communication status reply message, thereby inspecting whether or not the media converter 160b has any trouble (Step S1115). In a case where the media converter 160b has trouble, the controller 510 in the management apparatus 180 records the communication status of the media converter 160b (Step S1160), and this sequence is finished. In a case where the media converter 160b has no trouble, the interconnection resume unit 560 transmits the interconnection setting message to the media converter 160b, thereby releasing the prohibition of the transmission to the UTP cable 145c and the optical fiber 155c by the media converter 160b (Step S1120). Then, the sequence goes to Step S1105.

The controller 510 in the management apparatus 180 changes the object of the detection to the media converter 160c, when receiving the communication status reply message from the media converter 160c after Step S1105 (Step S1130). Then, the controller 510 in the management apparatus 180 acquires the communication state of the media converter 160c stored in the communication state reply message, thereby inspecting whether or not the media converter 160c has any trouble (Step S1135). In a case where the media converter 160c has trouble, the controller 510 in the management apparatus 180 records the communication status of the media converter 160c (Step S1160), and this sequence is finished. In a case where the media converter 160c has no trouble, the interconnection resume unit 560 in the management apparatus 180 transmits the interconnection setting message to the media converter 160c, so that the prohibition of the transmission to the optical fiber 155c and the UTP cable 165c by the media converter 160c is released (Step S1140). Then, the sequence goes to Step S1105.

When receiving the communication status reply message from the terminal 170c after Step S1105, the controller 510 in the management apparatus 180 sets the object of the detection to be none (Step S1150). The controller 510 in the management apparatus 180 then records that the communication between the interconnecting apparatus 140 and the terminal 170c is normal (Step S1160), and this sequence is finished.

By the above operations, the management apparatus 180 can acquire the communication status(es) between the interconnecting apparatus 140 and the terminal 170c by using the communication status get message.

For example, in a case where the receiving from the UTP cable 165c in the media converter 160c is disconnected because of trouble, the media converter 160c prohibits the transmission to the optical fiber 155c and the UTP cable 165c so as to be disconnected. Then, since the receiving from the optical fiber 155c has been disconnected, the media converter 160b then disconnects the transmission to the UTP cable 145c and the optical fiber 155c. In this case, the controller 510 in the management apparatus 180 receives, from the media converter 160b, a reply to the communication status get message sent for the terminal 170c. This is because the transmission from the media converter 160b to the optical fiber 155c is disconnected and therefore the media converter 160b transmits the reply message responding to the communication status get message to the management apparatus 180.

Then, the interconnection resume unit 560 in the management apparatus 180 releases the disconnection of the transmission from the media converter 160b to the optical fiber 155c that was prohibited by the interconnection prohibit unit 330 in the media converter 160b. After this, the controller 510 in the management apparatus 180 transmits the communication status get message for the terminal 170c, via the interconnecting apparatus 140. In this case, the controller 510 in the management apparatus 180 receives, from the media converter 160c, a reply to the communication status get message sent for the terminal 170c. This is because the transmission from the media converter 160c to the UTP cable 165c is disconnected and therefore the media converter 160c transmits the reply message responding to the communication status get message to the management apparatus 180.

In the above manner, the management apparatus 180 can get the communication statuses of the media converter 160b and the media converter 160c in that order by using the communication status get message for the terminal 170c and the interconnection setting message, so as to inspect the presence or absence of trouble.

As described above, the management apparatus 180 according to the present embodiment can perform the trouble inspecting operation for the media converters 160b and 160c by using the communication path between the interconnecting apparatus 140 and the terminal 170c. Thus, the management apparatus 180 according to the present embodiment can manage the media converters 160b and 160c without using an exclusive or separate cable for management. Moreover, each of the media converters 160b and 160c of the present embodiment sends the reply message responding to the management message to the management apparatus 180 in a case where the transmission to a following or succeeding (i.e., downstream) communication device is prohibited. Since the management message convert unit 820a in each of the media converters 160b and 160c generates the reply message by changing a part of the management message, a smaller scale circuit can be realized as compared to a case where the reply message is newly generated.

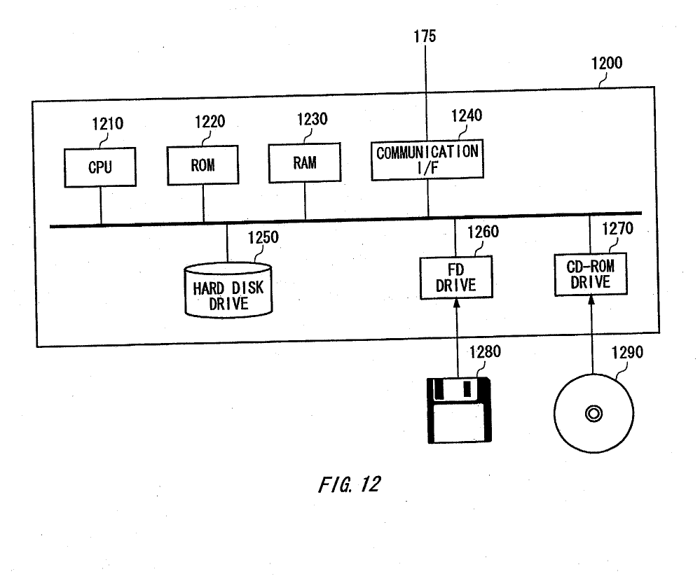

FIG. 12 shows an exemplary hardware configuration of the management apparatus 180 according to an embodiment of the present invention. The functions of the management apparatus 180 of the present embodiment are realized by cooperation of a computer 1200, which includes a CPU 1210; a ROM 1220; a RAM 1230; a communication interface 1240; and a hard disk drive 1250, and at least one program executed on the computer 1200. The computer 1200 may further include a floppy disk drive 1260 and/or a CD-ROM drive 1270.

The program for realizing the management apparatus 180 includes a management command receive module, a controlling module, a management command reply module, a management command transmit module, a reply command receive module, a monitoring module, an interconnection resume module, a management message transmit module and a reply message receive module. These modules are programs for making the computer 1200 operate as the management command receive unit 500, the controlling unit 510, the management command reply unit 520, the management command transmit unit 530, the reply command receive unit 540, the monitoring unit 550, the interconnection resume unit 560, the management message transmit unit 570, and the reply message receive unit 580.

The aforementioned program may be stored in an external storage medium. As the storage medium, other than a floppy disk 1280 and a CD-ROM 1290, an optical recording medium, such as a DVD or a PD, a magneto-optical recording medium, such as an MD, a tape-like medium, or a semiconductor memory, such as an IC card, may be used. Moreover, a storage device such as a hard disk or a RAM provided in a server system connected to an exclusive communication network or the Internet may be used as the storage medium, so that the program can be provided to the computer 1200 through an external network or a network connected to the computer 1200.

In the above described embodiments of the present invention, when generating the communication status reply message by converting the communication status get message, the management message convert units 820a and 820b in the media converter 160a may exchange the destination MAC address and the source MAC address in Ethernet flame containing the communication status get message for each other, in addition to the operation shown in FIG. 9.

As is apparent from the above, according to the present invention, management of a network formed by a plurality of interconnecting apparatuses can be accomplished with reduced management work and cost.

Although the present invention has been described byway of exemplary embodiments, it should be understood that those skilled in the art might make many changes and substitutions without departing from the spirit and the scope of the present invention which is defined only by the appended claims.

1. A communication system, comprising:
a first interconnecting apparatus connected to an external network, said first interconnecting apparatus comprising a first interconnecting unit operable to receive a first management command from the external network;
a second interconnecting apparatus connected to said first interconnecting apparatus; and
a first management apparatus, connected to both said first interconnecting apparatus and said second interconnecting apparatus, said first management apparatus comprising a first management command receive unit operable to receive the first management command from said first interconnecting apparatus, the first management command including an instruction for management of said second interconnecting apparatus.

2. A communication system as claimed in claim 1, wherein said second interconnecting apparatus comprises a second interconnecting unit connecting to said first interconnecting apparatus through a first transmission medium and to another apparatus through a second transmission medium which is different from said first transmission medium in a physical layer.

3. A communication system as claimed in claim 1, wherein said second interconnecting apparatus comprises:
a second interconnecting unit connecting to said first communication apparatus through a first transmission medium and to another apparatus through a second transmission medium; and
a first interconnection prohibit unit connecting to said second interconnecting unit, said first interconnecting prohibit unit operating said second interconnecting unit to disconnect transmission both to said first transmission medium and to said second transmission medium when transmission from either said first transmission medium or said second transmission medium is disconnected.

4. A communication system as claimed in claim 3, wherein said first management apparatus comprises:
a monitoring unit, operable to monitor communication between said first interconnecting apparatus and said second interconnecting apparatus if it is disconnected;
an interconnection resume unit operable to release the disconnection of the transmission to said second transmission medium by said first interconnection prohibit unit of said second interconnecting apparatus when communication between said first interconnecting apparatus and said second interconnecting apparatus is disconnected;
a management message transmit unit 570 operable, in a case where said interconnection resume unit releases the disconnection of the transmission to said second transmission medium by said first interconnection prohibit unit, to transmit a communication status get message, that is sent to a communication device connected to said second interconnecting apparatus via said second transmission medium, for getting a communication status of said communication device; and
a reply message receive unit operable to receive, from said communication device, a communication status reply message that is a reply to said communication status get message.

5. A communication system as claimed in claim 4, wherein said management message transmit unit transmits said communication status get message to said second interconnecting apparatus, and said second interconnecting apparatus transmits said communication status get message, received from said management message transmit unit, to said communication device.

6. A communication system as claimed in claim 4, wherein said second interconnecting apparatus includes a second interconnecting unit operable to perform medium conversion between a first transmission medium and a second transmission medium, said first transmission medium being used for connection with said first interconnecting apparatus and said second transmission medium being different from said first transmission medium in a physical layer;
said management message transmit unit transmits said communication status get message to said first interconnecting apparatus,
said first interconnecting unit in said first interconnecting apparatus transmits said communication status get message, received from said management message transmit unit, to said second interconnecting apparatus, and
said second interconnecting unit in said second interconnecting apparatus transmits said communication status get message, received from said first interconnecting unit, to said communication device.

7. A communication system as claimed in claim 1, further comprising:
a third interconnecting apparatus connected to said second interconnecting apparatus; and
a second management apparatus, connected to said first management apparatus, operable to manage said third interconnecting apparatus, said
second management apparatus comprising a second management command receive unit operable to receive, from said first management apparatus, a second management command for managing said third interconnecting apparatus.

8. A communication system as claimed in claim 7, wherein said second interconnecting apparatus includes a second interconnecting unit operable to perform medium conversion between a first transmission medium, used for connection with said first interconnecting apparatus, and a second transmission medium, different from said first transmission medium in a physical layer, and said third interconnecting apparatus includes a third interconnecting unit operable to perform medium conversion between said second transmission medium, used for connection with said second interconnecting apparatus, and a third transmission medium, different from said second transmission medium in a physical layer.

9. A communication system as claimed in claim 2, further comprising:
a third interconnecting apparatus, connected to said second interconnecting apparatus, operable to perform medium conversion between said second transmission medium, used for connection with said second interconnecting apparatus, and a third transmission medium, different from said second transmission medium in a physical layer, wherein
said third interconnecting apparatus comprises:
an interconnection prohibit unit operable, in a case where transmission receiving from said second transmission medium or said third transmission medium is disconnected, to disconnect transmission to said second transmission medium and said third transmission medium;
a management message receive unit operable to receive, from said second transmission medium, a communication status get message for getting a communication status of a communication path including said second transmission medium, said third interconnecting apparatus and said third transmission medium;
a management message convert unit operable to change a part of said communication status get message to information indicating a communication status of said third interconnecting apparatus, to generate a communication status reply message having a same length as said communication status get message; and
a management message reply unit operable, when said interconnection prohibit unit disconnects the transmission to said third transmission medium, to transmit said communication status reply message, via said second transmission medium, to said first management apparatus.

10. A communication system as claimed in claim 9, wherein said communication status get message is an echo message in Internet Control Message Protocol (ICMP), said communication status reply message is an echo reply message in ICMP, and said management message convert unit changes said echo message to said information indicating said communication status of said third interconnecting apparatus by interchanging a source IP address and a destination IP address in an IP header of said echo message.

11. An interconnecting apparatus for connecting a first transmission medium and a second transmission medium to each other, comprising:
an interconnection prohibit unit operable to disconnect transmission to said second transmission medium when a predetermined condition is satisfied;
a management message receive unit operable to receive, via said first transmission medium, a communication status get message for getting a communication status of a communication path including said first transmission medium, said interconnecting apparatus and said second transmission medium;
a management message convert unit operable to change a part of fields of said communication status get message to information indicating a communication status of said interconnecting apparatus to generate a communication status reply message having a same length as said communication status get message; and
a management message reply unit operable to send back said communication status reply message, via said first transmission medium, when the transmission to said second transmission medium is disconnected.

12. An interconnecting apparatus as claimed in claim 11, wherein said second transmission medium is different from said first transmission medium in a physical layer, and said interconnecting apparatus further includes an interconnecting unit operable to perform medium conversion between said first transmission medium and said second transmission medium.

13. An interconnecting apparatus as claimed in claim 11, wherein said communication status get message is an echo message in Internet Control Message Protocol (ICMP), said communication status reply message is an echo reply message in ICMP, and said management message convert unit changes said part of said fields of said echo message, as said communication status get message, to said information indicating said communication status of said interconnecting apparatus by interchanging a source IP address and a destination IP address in an IP header of said echo message.

14. A communication system management method for managing a communication system having a first interconnecting apparatus connected to an external network; a second interconnecting apparatus connected to said first interconnecting apparatus; and a management apparatus operable to manage said second interconnecting apparatus, said management apparatus being connected to said first interconnecting apparatus and said second interconnecting apparatus, the method comprising:
receiving, by said first interconnecting apparatus, a management command, as an instruction for management of said second interconnecting apparatus, said management command originating from said external network, and
transmitting said management command to said management apparatus;
receiving, by said management apparatus, said management command transmitted by said first interconnecting apparatus; and
managing, by said management apparatus, said second interconnecting apparatus in accordance with said management command.

15. An interconnecting apparatus controlling method for controlling an interconnecting apparatus that connects a first transmission medium and a second transmission medium to each other, said method comprising:
disconnecting transmission to said second transmission medium when a predetermined condition is satisfied;
receiving, via said first transmission medium, a communication status get message for getting a communication status of a communication path including said first transmission medium, said interconnecting apparatus and said second transmission medium;
changing a part of fields of said communication status get message to information indicating a communication status of said interconnecting apparatus to generate a communication status reply message having a same length as said communication status get message; and
sending back said communication status reply message, via said first transmission medium, when the transmission to said second transmission medium is disconnected.

16. A program for a management apparatus in a communication system including a first interconnecting apparatus connected to an external network and a second interconnecting apparatus connected to said first interconnecting apparatus, said management apparatus being operable to manage said second interconnecting apparatus, wherein said second interconnecting apparatus includes: an interconnecting unit operable to interconnect communication between a first transmission medium, used for connection with said first interconnecting apparatus, and a second transmission medium; and an interconnection prohibit unit operable to disconnect transmission to said first transmission medium and said second transmission medium by said interconnecting unit, in a case where transmission receiving from said first transmission medium or said second transmission medium is disconnected, wherein said program comprises:
a monitoring unit operable to monitor whether or not communication between said first interconnecting apparatus and said second interconnecting apparatus is disconnected;
an interconnection resume unit operable, in a case where the communication between said first interconnecting apparatus and said second interconnecting apparatus is disconnected, to release the disconnection of transmission to said second transmission medium by said interconnection prohibit unit;
a management message transmit unit operable, in a case where said interconnection resume unit releases the disconnection of transmission to said second transmission medium by said interconnection prohibit unit, to transmit a communication status get message, for getting a communication status of a communication device connected to said second interconnecting apparatus via said second transmission medium, to be sent to said communication device; and
a reply message receive unit operable to receive a communication status reply message, as a reply to said communication status get message, from said communication device.

17. A recording medium having a program stored therein for use with a management apparatus in a communication system including a first interconnecting apparatus connected to an external network and a second interconnecting apparatus connected to said first interconnecting apparatus, said management apparatus being operable to manage said second interconnecting apparatus, wherein said second interconnecting apparatus includes: an interconnecting unit operable to interconnect communication between a first transmission medium, used for connection with said first interconnecting apparatus, and a second transmission medium; and an interconnection prohibit unit operable to disconnect transmission to said first transmission medium and said second transmission medium by said interconnecting unit, in a case where transmission receiving from said first transmission medium or said second transmission medium is disconnected, wherein said program comprises:
a monitoring unit operable to monitor whether or not communication between said first interconnecting apparatus and said second interconnecting apparatus is disconnected;
an interconnection resume unit operable to release the disconnection of the transmission to said second transmission medium by said interconnection prohibit unit, in a case where communication between said first interconnecting apparatus and said second interconnecting apparatus is disconnected;
a management message transmit unit operable to transmit a communication status get message, for getting a communication status of a communication device connected to said second interconnecting apparatus via said second transmission medium, to be sent to said communication device, in a case where said interconnection resume unit released the disconnection of the transmission to said second transmission medium by said interconnection prohibit unit; and
a reply message receive unit operable to receive a communication status reply message, that is a reply to said communication status get message, from said communication device.
